(19) United States
(12) Patent Application Publication
(10) Pub. No.: US 2013/0043781 A1
(43) Pub. Date: Feb. 21, 2013

(54) INTEGRAL LAMP WITH A REPLACEABLE LIGHT SOURCE

(71) Applicant: Robert WANG, Luch (TW)

(72) Inventor: Robert WANG, Luch (TW)

(21) Appl. No.: 13/209,589

(22) Filed: Aug. 15, 2011

(51) Int. Cl. H01J 7/24

(52) U.S. Cl. 313/46

(57) ABSTRACT

An integral lamp with a replaceable light source includes a bulb base, an LED light emitting module and a lamp hood. The bulb base is integrally made of aluminum, with the LED light emitting module and the lamp hood independently assembled on or disassembled from the bulb base in order. Heat generated by the LED light emitting module can be directly scattered out by the bulb bas, without installing any extra heat dispersing device so as to simplify the structure of the lamp and lower assembling cos. And with the bulb base polished, light reflection can be enhanced. The LED light emitting module can be swiftly disassembled for maintenance or being replaced with a new one if breaking down, with the other components remaining still usable. So waste can be reduced to be friendly to environment.

### BACKGROUND OF THE INVENTION

1. Field of the Invention

This invention relates to an integral lamp with a replaceable light source.

2. Description of the Prior Art

As LED lamps have advantages of low energy consumption, high efficiency, a short response time, a long service life and containing nothing unfriendly to environment, such as mercury, they have been gradually replacing conventional lamps, such as a fluorescent lamp or an energy-saving lamp. However, service life and reliability of the LED lamps depend on temperature. If heat generated by LED lamps cannot be properly dispersed out, it is to make LED interface over heated to downgrade light emitting efficiency, stability and service life. That is, the higher the temperature is, the shorter the service life is. For an LED lamp, an LED module is usually the only component that is apt to break down. So a heat dispersing module, such as heat dispersing fins or tubes, is always additionally installed in an LED lamp to step up dispersing effect. But, with the heat dispersing module, it is to augment structural complexity, manufacturing cost and assembling difficulty of the LED lamp.

### SUMMARY OF THE INVENTION

The object of this invention is to offer an integral lamp with a replaceable light source, with advantages of excellent heat dispersing ability, a simple manufacturing process and saving energy.

The main characteristics of the invention are a bulb base, an LED light emitting module and a lamp hood. The LED light emitting module is installed on a bottom plate of the bulb base, able to be disassembled. The LED light emitting module is provided with a base made of aluminum, a circuit board inserted in one side of the base corresponding to the bottom plate, plural LEDs and a circuit driving unit located on one side of the circuit board opposite to the bottom plate, and a power plug positioned on one side of the circuit board facing to the bottom plate and inserted through the base to engage with the socket. The lamp hood is made of a transparent material, installed on the bulb base.

By means of the bulb base, heat generated by the LED light emitting module can be directly transmitted and scattered into the atmosphere without necessity to install any extra heat dispersing means, able to simplify the structure of the lamp and lower assembling cost. The bulb base can also be polished to enhance reflection of light. With the bulb base and the lamp hood able to be designed variously according to requirement, the lamp is not merely a lamp, but a decoration also. In case the LED light emitting module breaks down, it can be quickly disassembled for maintenance or being replaced with a new one without throwing away the whole lamp, not only simplifying manufacturing and assembling process, but also lessen waste to save energy.

### BRIEF DESCRIPTION OF DRAWINGS

This invention is better understood by referring to the accompanying drawings, wherein:

FIG. 1 is a perspective view of a first preferred embodiment of an integral lamp with a replaceable light source in the present invention;

FIG. 2 is an exploded perspective view of the first preferred embodiment of an integral lamp with a replaceable light source in the present invention;

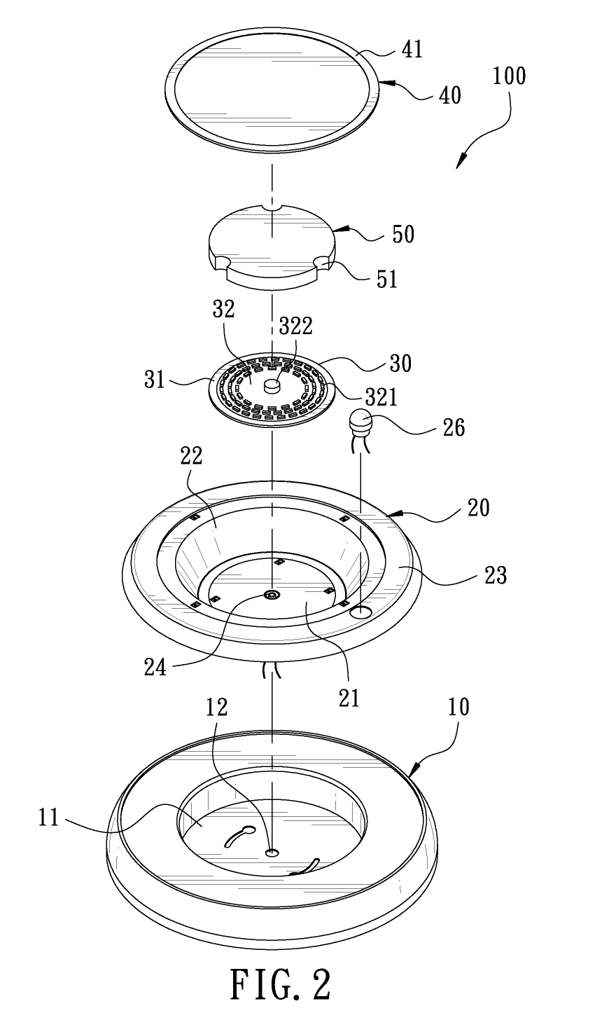

FIG. 3 is another exploded perspective view of the first preferred embodiment of an integral lamp with a replaceable light source in the present invention;

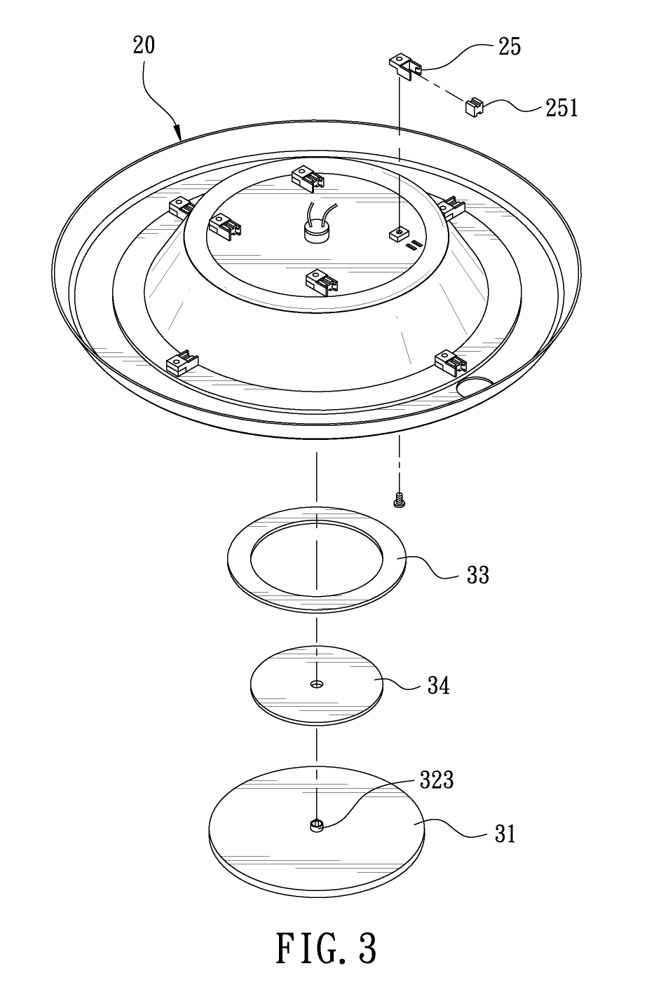

FIG. 4 is a cross-sectional view of the first preferred embodiment of an integral lamp with a replaceable light source in the present invention;

FIG. 5 is a cross-sectional view of a second preferred embodiment of an integral lamp with a replaceable light source in the present invention;

FIG. 6 is a cross-sectional view of a third preferred embodiment of an integral lamp with a replaceable light source in the present invention; and

FIG. 7 is a cross-sectional view of a fourth preferred embodiment of an integral lamp with a replaceable light source in the present invention.

### DETAILED DESCRIPTION OF THE PREFERRED EMBODIMENT

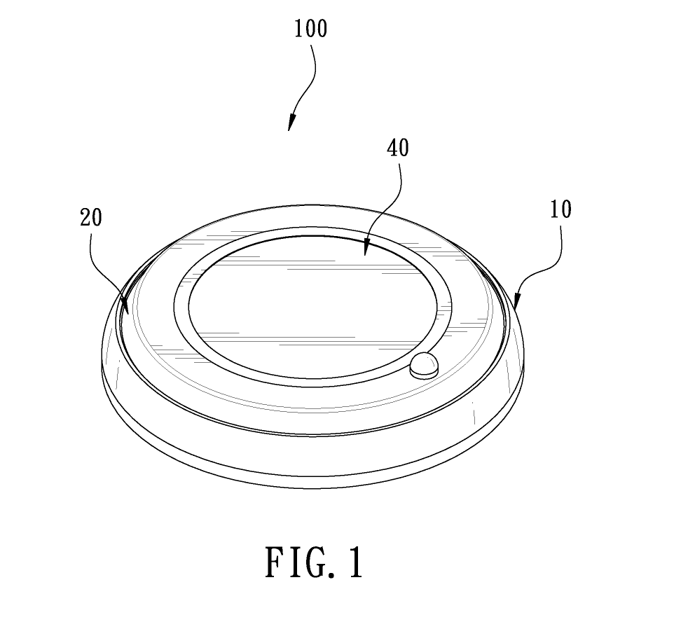

As shown in FIGS. 1˜3, a first preferred embodiment of an integral lamp 100 with a replaceable light source in the present invention is composed of a base plate 10, a bulb base 20, an LED light emitting module 30, a lamp hood 40 and a bulb cap 50.

The base plate 10 is integrally made of steel, provided with a round accommodating groove 11 formed in the center, and plural fixing holes 12 bored in the bottom of the accommodating groove 11 for plural fixing members (not shown in Figs.) to insert through to keep the base plate 10 positioned on a wall or a ceiling.

The bulb base 20 is fitted in the accommodating groove 11 of the base plate 10, integrally made of aluminum apt to disperse heat, with a shape similar to a disc. The bulb base 20 is provided with a bottom plate 21, a circumferential wall 22 extended upward around the outer circumference of the bottom plate 21, a heat dispersing portion 23 horizontally extending outward from the free side of the circumferential wall 22, and a socket 24 installed at the center of the bottom plate 21 to connect to a power source by a wire (not shown in Figs.). Furthermore, plural magnetic units 25 are located on the bottom plate 21 around the socket 24, respectively provided with a powerful magnet 251 to enable the bulb base 20 magnetically positioned on the base plate 10. In the preferred embodiment of the invention, the socket 24 is a coaxial annular metallic base, with a connecting point formed inside to become a non-polar contact. Plural magnetic units 25 are additionally built on the heat dispersing portion 23. And the bulb base 20 can have the surface polished to enhance light reflection.

The LED light emitting module 30 is detachable and installed on the bottom plate 21 of the bulb base 20. The LED light emitting module 30 is provided with a base 31 made of aluminum, a circuit board 32 inserted in one side of the base 31 corresponding to the bottom plate 21, and a steel ring 33 and a heat dispersing rubber washer 34 attached on one side of the base 31 opposite to the bottom plate 21. In addition, plural LEDs 321 and a circuit driving unit 322 are located on one side of the circuit board 32 opposite to the bottom plate 21, and a power plug 323 is positioned on one side of the circuit board 32 facing to the bottom plate 21 and inserted through the base 31. In the preferred embodiment of the invention, the power plug 323 is a coaxial annular metallic terminal used to engage with the socket 24 freely in any angle. By means of the steel ring 33 magnetically combined with the powerful magnets 251 of the bulb base 20, the LED light emitting module 30 is fixed with the bulb base 20. Instead of magnetic combination, the LED light emitting module 30 can also be fixed with the bulb base 20 by screwing up or locking up, but not limited.

The lamp hood 40 is made of transparent acrylic, shaped similar to a round plate for matching with the bulb base 20, permissible to be decorated with a picture (not shown in Figs.) so as to project the picture on the ground after being lit up by the LED light emitting module 30. The lamp hood 40 is provided with a steel ring 41 fitted around the outmost circumference for being magnetically combined with the heat dispersing portion 23, so that the lamp hood 40 can be magnetically stabilized on the bulb base 20.

The lamp cap 50 is integrally made of a transparent material, fixed on the top of the LED light emitting module 30. The lamp cap 50 is provided with plural notches 51 cut in the circumference for a user to maintain conveniently while disassembling the LED light emitting module 30 and the lamp cap 50 from the bulb base 20.

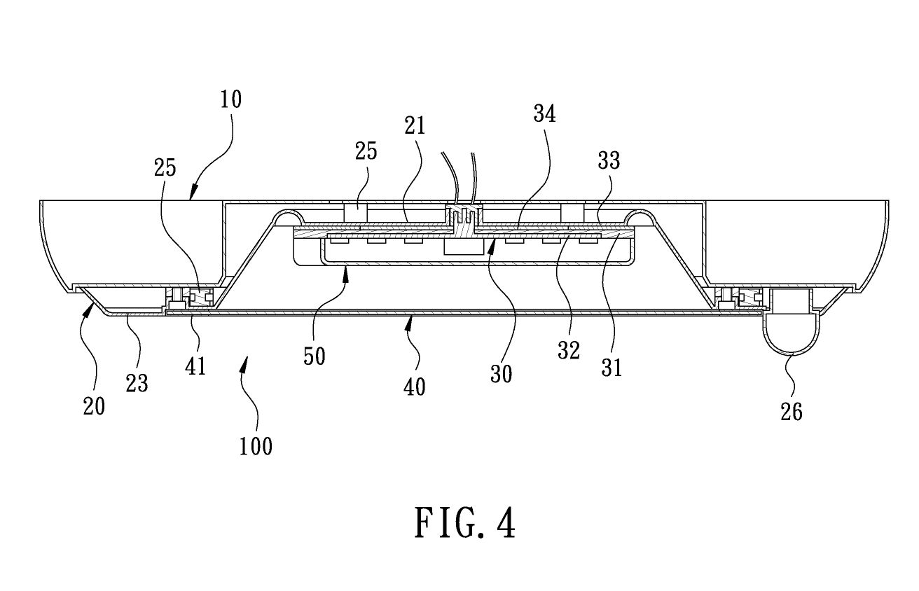

In assembling, as shown in FIG. 4, the integral lamp 100 is for instance to be installed on a ceiling. The base plate 10 is first positioned on the ceiling. Next the bulb base 20, the LED light emitting module 30 and the lamp hood 40 are successively fitted to the base plate 10, conveniently combined together by magnetic attraction; they can naturally be disassembled as easily as being assembled. And as the bulb base 20 is integrally made of aluminum and closely combined with the LED light emitting module 30, the heat generated by the LED light emitting module 30 can directly travel through the base 31 and the heat dispersing rubber washer 34 to the bottom plate 21 and the heat dispersing portion 23 of the bulb base 20 so as to quickly scatter into the atmosphere, needing no extra heat dispersing means, such as heating dispersing fins or tubes. Thus the integral lamp 100 has a simple structure and manufacturing process, and a low cost.

Moreover, a detector 26, such as a human detector, a fire detector, an earthquake detector or other warning detectors, can be fixed on the bulb base 20.

Further, as the LED light emitting module 30 and the bulb base 20 are merely combined together by magnetic attraction, they can be easily separated apart as long as the power plug 323 is pulled out of the socket 24. So can the LED light emitting module 30 be replaced with a new one if it breaks down. It should be noticed that if the integral lamp 100 does not work, it is mostly due to the damage of the light source as it is the weakest component in the integral lamp 100. That is, the power source component (AC/DC power conversion circuit and constant current circuit) is a component not apt to get damaged. Thus it is only necessary to replace the damaged component with a new one instead of throwing away the whole lamp, not only saving money for users, but also lessening waste to be friendly to environment. Furthermore, by changing light color, brightness and watts of bulbs, a user can choose and change the LED light module 30 freely.

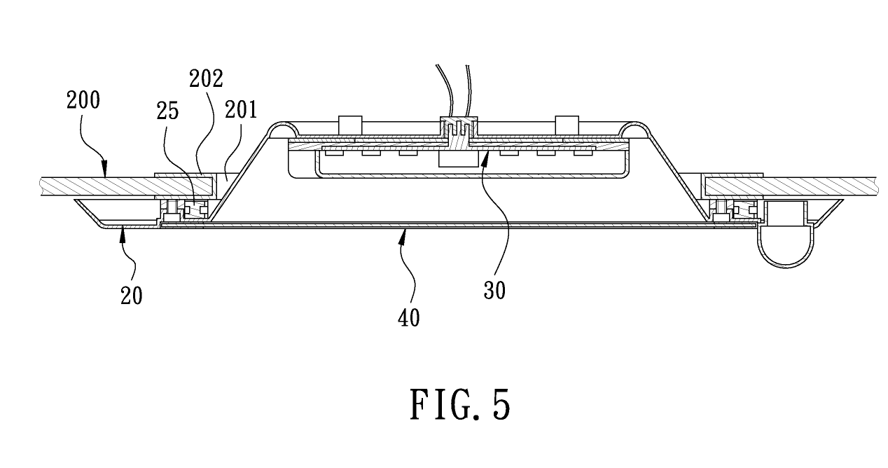

FIG. 5 shows a second preferred embodiment of an integral lamp 100 with a replaceable light source in the present invention, having most components the same as those of the first embodiment does. The different point is that the integral lamp 100 is a recessed light inserted in a decorating ceiling 200. The decorating ceiling 200 is bored with an opening 201 to accommodate the integral lamp 100, with plural U-shaped steel plates 202 clamping the decorating ceiling 200 around the opening 201 for being magnetically attracted by the magnetic units 25 to make the bulb base 20 attached with the decorating ceiling 200. As described in the first embodiment, the LED light emitting module 30 and the lamp hood 40 are orderly installed on the bulb base 20, magnetically attracted by the magnetic units 25; and the heat generated by the LED light emitting module 30 can be dispersed into atmosphere by the bulb base 20.

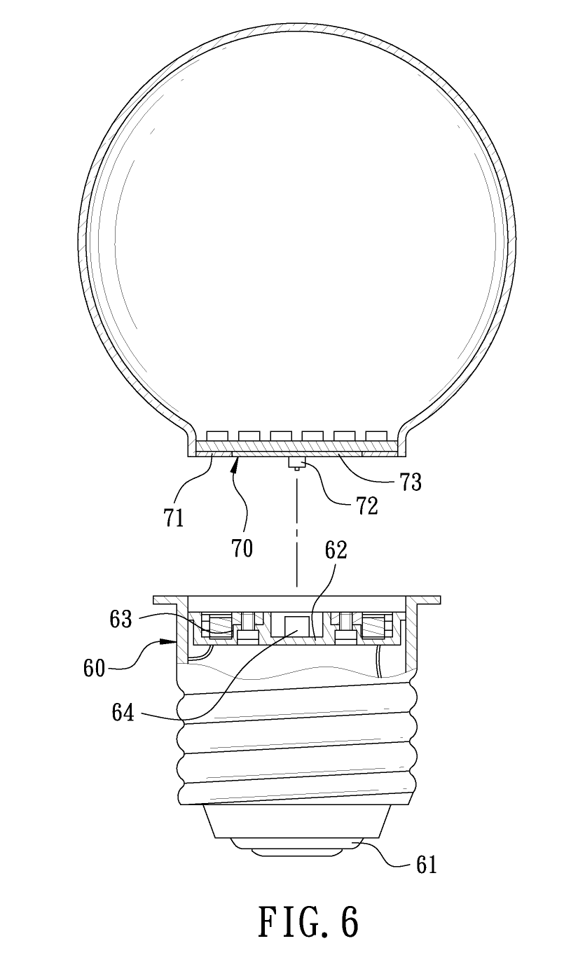

FIG. 6 shows a third preferred embodiment of an integral lamp 100 with a replaceable light source in the present invention, having most components the same as those of the first embodiment does. The different point is that the integral lamp 100 is an LED bulb, provided with a bulb base 60 and an LED light emitting module 70. The bulb base 60 is integrally made of aluminum, provided with a metallic threaded portion 61 formed at one side, an aluminum supporting plate 62 extended inward from another side, plural magnetic units 63 and a socket 64 fixed on the supporting plate 62. The LED light emitting module 70 has an annular steel plate 71 and a power plug 72 located at the bottom to respectively correspond to the magnetic units 63 and the socket 64 so as to magnetically combine with the supporting plate 62 of the bulb base 60 and get electrically connected. In addition, a heat dispersing rubber washer 73 is attached to the interior of the annular steel plate 71, employed to conduct the heat through the bulb base 60 to scatter out.

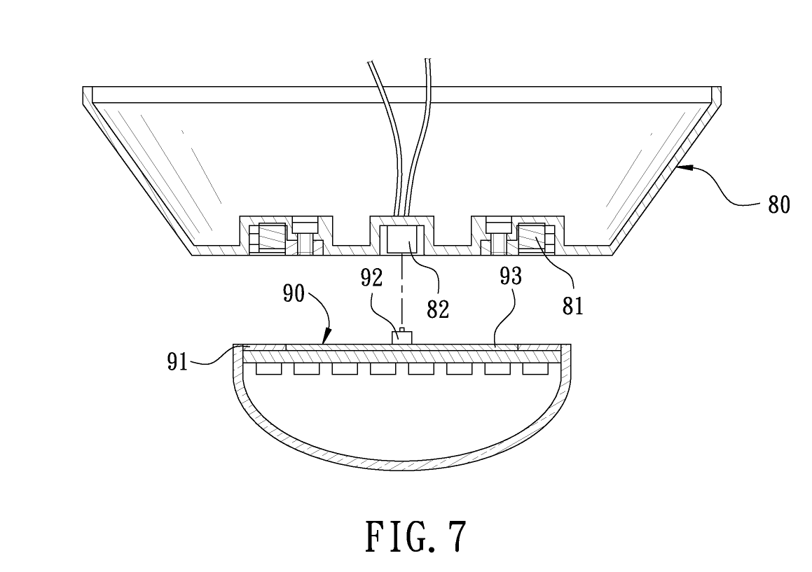

FIG. 7 shows a fourth preferred embodiment of an integral lamp 100 with a replaceable light source in the present invention, having most components the same as those of the first embodiment does. The different point is that the integral lamp 100 is an LED fluorescent lamp, provided with a bulb base 80 and an LED light emitting module 90. The bulb base 80 is integrally made of aluminum, provided with plural magnetic units 81 and a socket 82 fixed on a bottom surface. The LED light emitting module 90 has an annular steel plate 91 and a power plug 92 located at the bottom to respectively correspond to the magnetic units 81 and the socket 82 so as to magnetically combine with the bulb base 80 and get electrically connected. In addition, a heat dispersing rubber washer 93 is attached to the bottom of the LED light emitting module 90 to conduct the heat generated by the LED light emitting module 90 through the bulb base 80 to scatter out.

The invention has the following advantages as can be seen from the foresaid description.

1. With the LED light emitting module closely combined with the bulb base made of good heat-dispersing aluminum, the heat generated by the LED light emitting module can be swiftly scattered into the atmosphere, without necessity for an extra heat dispersing means, able to simplify structure of the lamp and its manufacturing process for lowering cost. And the bulb base can be polished to enhance reflection of light.

2. In the present integral lamp, the power source component and the light source component are independent from each other, but combined together by magnetic attraction, so they can be separated apart easily. In case LED bulbs break down, it just need to replace the light source component without necessity to replace the power source component that is not apt to get damaged. Thus not only can a user save money, but also waste can be shrunk to save energy.

3. The technique of the bulb base used to scatter heat can be applied on a tube light, a disc light, a stair light and a conventional threaded bulb.

4. With the bulb base and the lamp hood able to be designed variously, a user can install a lamp having a bulb base and a lamp hood with a proper color, shape and material as required. The lamp is not merely a lamp, but a decoration also.

While the preferred embodiment of the invention has been described above, it will be recognized and understood that various modifications may be made therein and the appended claims are intended to cover all such modifications that may fall within the spirit and scope of the invention.

What is claimed is:

1. An integral lamp with a replaceable light source, said integral lamp comprising:
a bulb base integrally made of aluminum and provided with a bottom base and a circumferential wall formed upward around an outer circumference of said bottom plate, a heat dispersing portion horizontally extending outward from a free side of said circumferential wall, a socket installed at a center of said bottom plate;
an LED light emitting module installed on said bottom plate of said bulb base and able to be disassembled, said LED light emitting module provided with a base made of aluminum, a circuit board inserted in one side of said base corresponding to the bottom plate, plural LED bulbs and a circuit driving unit inserted in one side of said circuit board opposite to said bottom plate, a power plug positioned on one side of said circuit board facing to said bottom plate and inserted through said base to engage with said socket of said bulb base; and
a lamp hood made of transparent acrylic for matching with said bulb base.

2. The integral lamp with a replaceable light source as claimed in claim 1, wherein said LED light emitting module is fixed with said bulb base by means of screwing.

3. The integral lamp with a replaceable light source as claimed in claim 1, wherein said LED light emitting module is fixed with said bulb base by means of fitting together.

4. The integral lamp with a replaceable light source as claimed in claim 1, wherein said LED light emitting module is fixed with said bulb base by means of magnetic attraction.

5. The integral lamp with a replaceable light source as claimed in claim 1, wherein said socket is a coaxial annular metallic base with a connecting point formed inside to become a non-polar contact and said power plug is a coaxial annular metallic terminal used to engage with said socket freely in any angle.

6. The integral lamp with a replaceable light source as claimed in claim 1, wherein said integral lamp is further provided with a steel base plate having a round accommodating groove formed in a center to contain said bulb base.

7. The integral lamp with a replaceable light source as claimed in claim 1, wherein said integral lamp is further provided with a lamp cap fixed on said LED light emitting module and integrally made of a transparent material, plural notches cut in a circumference of said lamp cup for a user to conveniently disassemble said LED light emitting module and said lamp cap from said bulb base.

8. The integral lamp with a replaceable light source as claimed in claim 1, wherein said lamp hood is further decorated with a picture so as to make the picture projected on a ground after being lit up by said LED light emitting module.
